(19) United States
(12) Patent Application Publication
(10) Pub. No.: US 2008/0148900 A1
(43) Pub. Date: Jun. 26, 2008

(54) Partitioned Gearbox

(75) Inventors: Michel Buannec, Verneuil-sur seine (FR); Philippe Cloud, Rueil Malmaison (FR); Marc Picard, Rueil Malmaison (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT s.a.s, Boulogne-billancourt (FR)

(21) Appl. No.: 11/815,157

(22) PCT Filed: Jan. 31, 2006
(86) PCT No.: PCT/FR2006/050081

§ 371 Date: Feb. 14, 2008

(30) Foreign Application Priority Data
Feb. 1, 2005 (FR) 0550296

(51) Int. Cl. F16H 57/02

(52) U.S. Cl. 74/606 R

(57) ABSTRACT

A motor vehicle gearbox with parallel shafts including a plurality of torque speed gears, including two concentric primary shafts alternately connected to the vehicle engine through first and second clutches, and two secondary shafts connected to the vehicle wheel through a differential. A first compartment contains at least one clutch, a second compartment contains hydraulic control elements, and a third compartment contains the gear selection mechanism of the gearbox.

The present invention relates to motor vehicle gearboxes comprising several parallel shafts, each fitted with a number of gears.

More particularly, the subject of the present invention is a motor vehicle gearbox with parallel shafts fitted with a plurality of gears, comprising two concentric primary shafts alternately connected to the vehicle engine by a first and a second clutch and two secondary shafts connected to the wheels of the vehicle by a differential.

This invention finds a favored, although nonlimiting, application in automated gearboxes with concentric primary shafts and double input clutches.

Publication DE 198 21 164 discloses a gearbox of the aforementioned type, known as a “double clutch gearbox”, comprising in the conventional way a housing in two parts joined together. These two housing parts, known as the “clutch housing” and the “mechanism housing” in actual fact define a single volume containing, on the one hand, the two clutches and, on the other hand, the gearbox internal control mechanism, that is to say the gears, the selector forks, the synchronizers and their automated control members including the distributor and the pump, together with gear selection and gearshift hydraulic actuators.

In this kind of architecture, the synchronizers and the gears, on the one hand, and the hydraulic control system on the other, use the same oil, flowing through all the housings. This arrangement presents difficulties because optimum gearbox operation requires the use of a relatively viscose oil for the synchronizers and the gears and a more fluid oil for the hydraulic control system. Furthermore, using the same oil to lubricate the mechanisms and in the hydraulic circuit carries the risk of degrading the latter because the oil becomes contaminated by lubricating the mechanism which means that it is prudent to provide a pressurized filter on the outlet side of the pump, in addition to the inlet filter. Finally, with oil that is too fluid it is not possible to coat the gears in phosphate in order to prevent them from wearing. This being the case, it is necessary to provide “additional length” on the gear teeth, in anticipation of this wear.

In order to deal with this problem, it has already been proposed for the gearbox oil to be heated when the vehicle starts. This measure makes it possible to reduce the viscosity of the oil quickly, so as to make it easier to operate the actuators when the vehicle starts to move. However, this solution entails sufficiently close control of the oil heating means in order to be satisfactory, or alternatively entails preventing the vehicle from moving forward until the oil has reached a sufficient temperature.

The present invention is aimed at completely eliminating the incompatibility between the lubrication of the mechanical components of a gearbox and the control of its clutches and actuators without penalizing the gearbox by increasing its size.

To this end, it proposes for the gearbox to have a first compartment containing at least one clutch, a second compartment containing hydraulic control elements, and a third compartment containing the gearshift mechanism of the gearbox.

The proposed measures are compatible with the size constraints associated with automated double clutch gearboxes.

Specifically, the mechanism in the third compartment may comprise an additional shaft of which the gear furthest from the engine is axially closer than or the same distance away as the furthest gear of a first secondary shaft, so as to limit the heightwise size of the gearbox.

In order to free up enough space in the top of the gearbox, on the opposite side to the engine, the first secondary shaft may also be shorter than the second secondary shaft.

Other features and advantages of the invention will become clearly apparent from the following description of one particular embodiment thereof, in conjunction with the attached drawings in which:

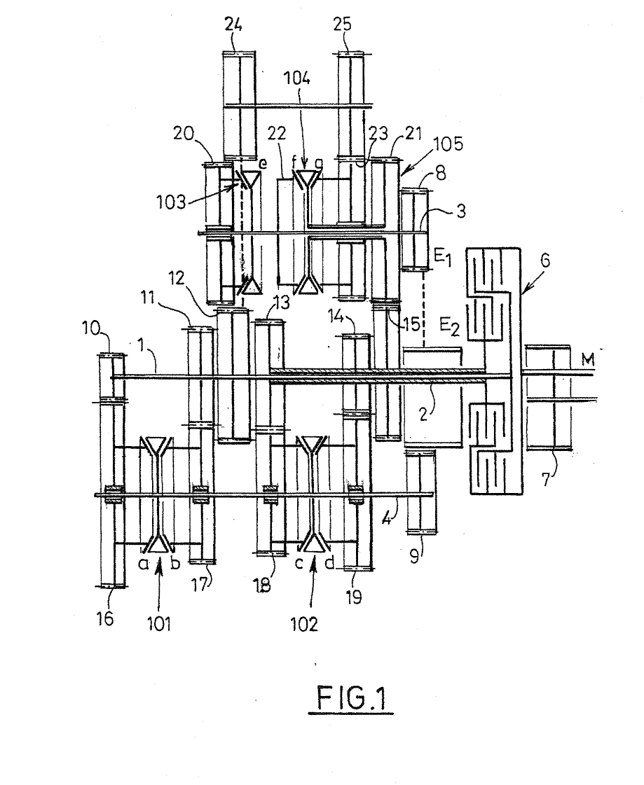

FIG. 1 is a diagrammatic depiction of the shafts and gears of a nonlimiting example of a gearbox according to the invention, and

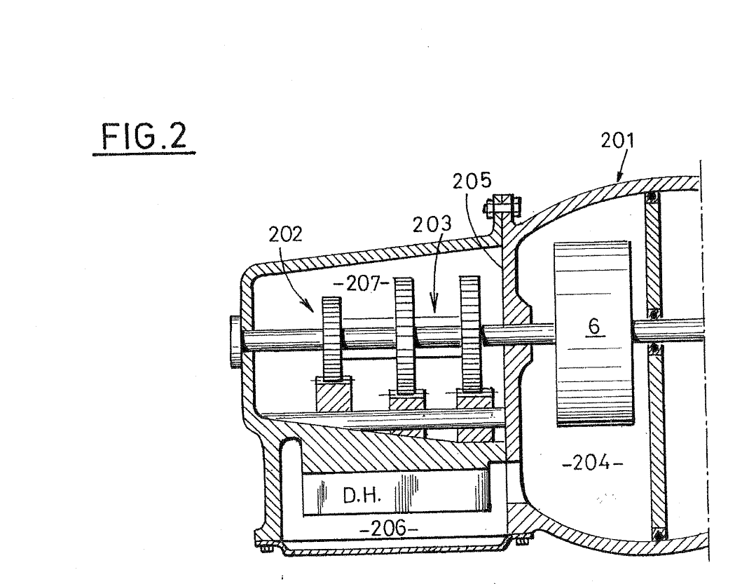

FIG. 2 reveals the main features thereof.

The gearbox illustrated in FIG. 1 comprises two concentric primary shafts 1, 2 connected to the engine M. The primary shaft 1 passes along inside the secondary shaft 2 and extends beyond the latter on the opposite side to the engine. Two secondary shafts 3, 4 and an additional shaft 5 are parallel to the primary shafts 1, 2. A double clutch system 6 and a differential 7 are diagrammatically depicted. The double clutch 6 comprises two concentric clutches E1, E2 connected to the engine M. The first clutch E1 is also connected to the first primary shaft 1, while the clutch E2 is connected to the second primary shaft 2. Each of the clutches E1, E2 can be declutched or let out such that the corresponding primary shaft 1, 2 is independent of the engine M, or engaged or let in such that the engine torque is transmitted to the corresponding primary shaft.

Each of the secondary shafts 3, 4 is equipped, at the engine end, with a differential-engaging gear referenced 8 and 9 respectively. The two differential-engaging gears 8, 9 engage with the same gear on the differential, which means that the engine torque can be transmitted to the wheels of the vehicle by either one of the two secondary shafts 3, 4. It will be noted that FIG. 1 is a flattened schematic depiction of the shafts which are not in actual fact coplanar. The rotational connection between the differential-engaging gear 8 and the differential 7 is depicted in dotted line in FIG. 1.

Each secondary shaft 3, 4 carries several idling gears and dog clutch systems allowing the various idling gears to be secured to their secondary shaft.

Starting from the opposite end to the engine, the first primary shaft 1 bears three fixed gears 10, 11, 12 secured to this shaft, while the second primary shaft 2 also bears three fixed gears 13, 14, 15.

The second secondary shaft 4 bears, on the opposite end to the engine, two idling gears 16, 17, connected to the same double dog clutch 101. When the dog clutch 101 is in position “a” in the figure, the secondary shaft 4 rotates as one with the gear 16. When it is in position “b”, the same shaft 4 rotates as one with the gear 17. The shaft 4 also bears, closer to the engine, another double dog clutch 102 by virtue of which the idling gears 18, 19 can be selectively connected to the primary shaft 4 according to whether this dog clutch is in position “c” or “d” in the figure.

Likewise, the first secondary shaft 3 is equipped, in its part furthest from the engine, with a single dog clutch 103, by virtue of which its idling gear 20 can be secured to this shaft in position “e”. The first secondary shaft 3 bears, at the engine end, an idling gear 21 and a double dog clutch 104, which rotates as one therewith. The first secondary shaft 3 also bears a gearwheel 22 that rotates as one therewith, and a gear 23 rotating freely about the assembly comprising the gear 21 and the double dog clutch 104.

When the double dog clutch 104 is in the neutral position, the gear 23, the gear 21 and double dog clutch 104 assembly and the primary shaft 3 are all free to rotate and independent of one another. When the dog clutch 104 is in position “f”, the gearwheel 22 rotates as one with the gear 21. When the dog clutch 104 is in position “g”, the gear 23 rotates as one with the gear 21.

Finally, the additional shaft 5 bears, at the opposite end to the engine, a gear 27 that rotates as one with this shaft and, at the engine end, a second fixed gear 25.

The gear furthest from the engine on the primary shaft 1 is the gear 10. It meshes with the gear 16 of the second secondary shaft 4. The second secondary shaft 4 is as long as the sum of the lengths of the two primary shafts because it is also connected at its front to the differential 7 via the gear 9. The gear 11 meshes with the gear 17, the gear 13 meshes with the gear 18, and the gear 14 meshes with the gear 19. Likewise, on the first secondary shaft 3, the gear 12 meshes with the gear 20 and the gear 15 meshes with the gear 21.

The gear 20, situated furthest from the engine on the first secondary shaft 3 meshes with the gear 12 which is the gear mounted closest to the engine on the first primary shaft 1. This same gear 12 in another spatial direction meshes with the gear 24 which is the gear mounted furthest from the engine on the additional shaft 5. The other gear 25 of the additional shaft 5 meshes with the gear 23 of the first secondary shaft 3.

The first secondary shaft 3 and the additional shaft 5, which are particularly short, allow the size of the gearbox to be reduced in the heightwise direction, on the opposite side to the engine. The space thus made available corresponds to the sum of the thicknesses of the gears 16, 17 and of the double dog clutch 101 positioned between these.

FIG. 2 gives a simplified depiction of a gearbox mechanism corresponding, for example, to that of FIG. 1, but which is not in any way limiting. FIG. 1 in actual fact in this respect is a simple example of application of the provisions of the invention.

This figure shows a cross section through a clutch housing 201 and a mechanism housing 202 of a gearbox such as that of FIG. 1. The housings 201, 202 have a coupling face 205. They respectively contain a double clutch 6 in a closed first compartment 204 and a gearshift mechanism 203 in a second closed compartment 206.

The mechanism 203 is, for example, one with parallel shafts equipped with a number of gears, comprising two concentric primary shafts alternately connected to the vehicle engine by a first and a second clutch, and two secondary shafts connected to the wheels of the vehicle by a differential in a way that may or may not be similar to FIG. 1.

According to the invention, it can be seen that this gearbox has a first compartment 204 containing at least a clutch, a second compartment 206 containing hydraulic control elements, and a third compartment 207 containing the gearshift mechanism 203, including the gears, the synchronizers and their actuators (not depicted), which may be electrical actuators and positioned outside the gearbox.

The elements of the second compartment include, for example, a pump and a hydraulic distributor DH, because the invention finds a favored application in automated double clutch gearboxes in which the clutches are of the “oil bath wet multi-plate” type. In a gearbox such as this, the clutches are controlled using a hydraulic distributor and hydraulic actuators, as in an automatic transmission.

As indicated above, the hydraulic control oil needs ideally to be a relatively fluid oil, of the type used in automatic transmissions with epicyclic gearboxes and hydrodynamic torque converters whereas the clutch mechanism is better lubricated with a more viscose conventional manual gearbox oil.

By compartmentalizing the housings as proposed by the invention it is possible to use different oils in the compartments 204, 206 on the one hand, and 207 on the other. Thus, all the mechanical elements, particularly the gears and the synchronizers, can be lubricated by an oil that is more viscose than the oil in the hydraulic control circuit. The first two compartments therefore preferably contain a more fluid oil than the third. As indicated in FIG. 2, the first compartment 204 is located in the clutch housing 201. Furthermore, it is desirable for the first two compartments 204, 206 to be in communication with one another.

The second compartment 206, which contains the hydraulic control elements, is advantageously positioned in the bottom of the gearbox, at the opposite side to the differential, while the third compartment 207, which for example contains the two primary shafts 1, 2, the two secondary shafts 3, 4 and an additional shaft 5 as in FIG. 1, is located in the top of the box, in the mechanism housing 202.

Finally, the first compartment 204 may advantageously contain a wet multiplate double clutch E1, E2.

As mentioned above, these provisions make it possible to dispense with the use of a special-purpose oil compatible both with the hydraulic elements and with the mechanical elements of the gearbox. Furthermore, there is no longer any need to make the gear teeth “extra long” because these teeth can be coated with phosphate. The separation of the oils finally makes it possible to switch easily between “dry” or “wet” clutches without altering the mechanical components of the gearbox (gearshift, gears, synchronizers etc.).

1-8. (canceled)

9. A motor vehicle gearbox with parallel shafts fitted with a plurality of torque speed gears, including two concentric primary shafts alternately connected to a vehicle engine by a first and a second clutch and two secondary shafts connected to the wheels of the vehicle by a differential, the gearbox comprising:
a first compartment containing at least one clutch;
a second compartment containing hydraulic control elements; and
a third compartment containing a gearshift mechanism of the gearbox,
wherein the first compartment is situated in the clutch housing and the second compartment contains a distributor and a hydraulic pump.

10. The gearbox as claimed in claim 9, wherein the gearshift mechanism comprises an additional shaft, of which a gear furthest from the vehicle engine is axially closer or a same distance away as a furthest gear of a first secondary shaft.

11. The gearbox as claimed in claim 10, wherein a first of the secondary shafts is shorter than a second of the secondary shafts.

12. The gearbox as claimed in claim 11, wherein a gear furthest from the vehicle engine, of a first secondary shaft, meshes with a gear closest to the vehicle engine of a first primary shaft.

13. The gearbox as claimed in claim 11, wherein the first and second compartments are in communication with one another.

14. The gearbox as claimed in claim 9, wherein the second compartment is positioned in the bottom of the gearbox, on an opposite side to the differential.

15. The gearbox as claimed in claim 9, wherein the third compartment is positioned in the top of the gearbox, in a housing of the gearbox mechanism.

16. The gearbox as claimed in claim 9, wherein the first and second compartments contain a more fluid oil than the third compartment.
